(19) United States
(12) Patent Application Publication
(10) Pub. No.: US 2024/0169203 A1
(43) Pub. Date: May 23, 2024

(54) FAST TARGET PROPAGATION FOR MACHINE LEARNING AND ELECTRICAL NETWORKS

(71) Applicant: Rain Neuromorphics Inc., San Francisco, CA (US)

(72) Inventor: Jack David Kendall, San Mateo, CA (US)

(21) Appl. No.: 18/516,474

(22) Filed: Nov. 21, 2023

Related U.S. Application Data
(60) Provisional application No. 63/427,653, filed on Nov. 23, 2022.

(51) Int. Cl. G06N 3/08; G06N 3/048

(52) U.S. Cl. CPC G06N 3/08; G06N 3/048

(57) ABSTRACT

A system including inputs, outputs, and a learning network between the inputs and outputs is described. The learning network includes layers, each of which includes a weight layer including weights coupled with an activation layer configured to apply activation function(s). Connections are between the layers. The system also includes a negative feedback network selectively couplable between the outputs and the inputs. The weights are configured to be trained by providing to the inputs input signals corresponding to a target output, measuring output signals at the outputs with the negative feedback network decoupled, perturbing the output signals by perturbations with the negative feedback network coupled, measuring corresponding perturbations for the connections, and updating the weights based on the corresponding perturbations. The perturbations are based on a difference between the output signals and the target output.

### CROSS REFERENCE TO OTHER APPLICATIONS

This application claims priority to U.S. Provisional Patent Application No. 63/427,653 entitled FAST TARGET PROPAGATION filed Nov. 23, 2022 which is incorporated herein by reference for all purposes.

### BACKGROUND OF THE INVENTION

Artificial intelligence (AI), or machine learning, utilizes learning networks loosely inspired by the brain in order to solve problems. Learning networks typically include layers of weights that weight signals (mimicking synapses) combined with activation layers that apply functions to the signals (mimicking neurons). The weight layers are typically interleaved with the activation layers. Thus, the weight layer provides weighted input signals to an activation layer. Neurons in the activation layer operate on the weighted input signals by applying some activation function (e.g. ReLU, leaky ReLU, or Softmax) and provide output signals corresponding to the statuses of the neurons. The output signals from the activation layer are provided as input signals to the next weight layer, if any. This process may be repeated for the layers of the network. Learning networks are thus able to reduce complex problems to a set of weights and the applied activation functions. The structure of the network (e.g., number of layers, connectivity among the layers, dimensionality of the layers, the values of the weights, the type of activation function, etc.) are together known as a model.

In order to be used in desired applications, the learning network is trained prior to its use. Training involves determining an optimal (or near optimal) configuration of the typically high-dimensional and nonlinear set of weights for each layer. Training may thus be considered to include providing an optimized solution to the credit assignment problem for the learning network.

One well accepted training technique is backpropagation. Backpropagation performs an inference on input signals (i.e. receives the input signals and provides output signals) and determines a loss function. The loss function quantifies the network's performance for a particular task, or error from a target output. The gradient of the loss function is determined and the weights in the final layer adjusted accordingly. The process of determining the gradient and adjusting the weights accordingly is propagated backwards through the network until the first layer of weights is adjusted. The entire process may be performed iteratively until the learning network converges to a solution of weights for each of the layers.

Although backpropagation functions in learning networks, it is also accepted that backpropagation does not accurately model biological networks. Calculation of the gradients for hidden layers (i.e. layers that are not the first layer or the final layer) of weights may also be challenging. Although techniques may be used for approximating the gradients for hidden layers, issues remain. For example, backpropagation may converge more slowly than desired. Stated differently, a large number of iterations may be required to settle on a solution for the assignment of weights. Moreover, the solution achieved may be less accurate than desired. Accordingly, what is desired is an improved technique for training and/or using learning networks.

### BRIEF DESCRIPTION OF THE DRA WINGS

Various embodiments of the invention are disclosed in the following detailed description and the accompanying drawings.

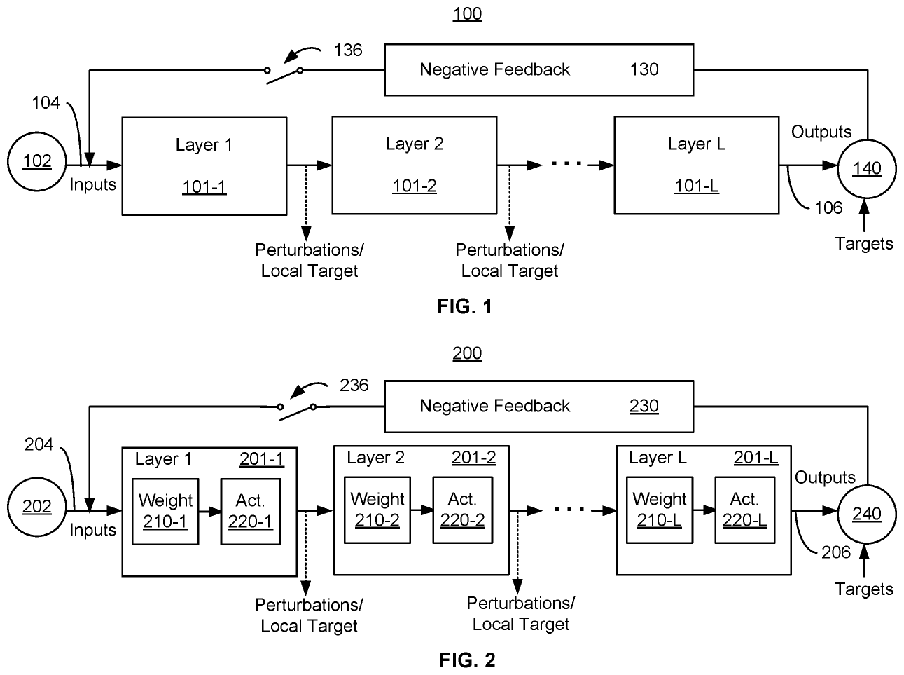

FIG. 1 depicts an embodiment of a network optimizable using fast target propagation with negative feedback.

FIG. 2 depicts an embodiment of a learning network trainable using fast target propagation with negative feedback.

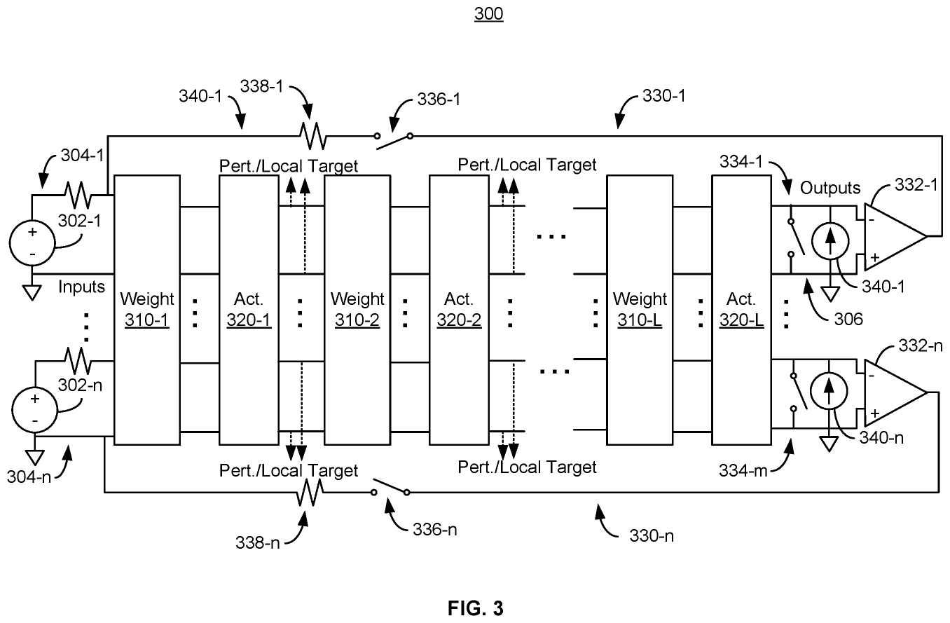

FIG. 3 depicts an embodiment of a learning network trainable using fast target propagation with negative feedback.

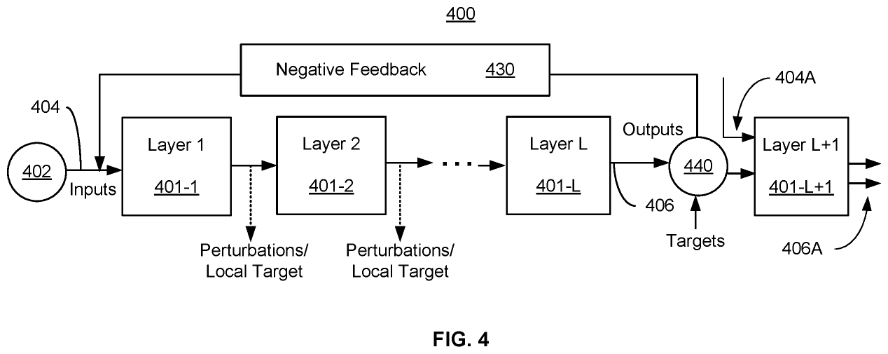

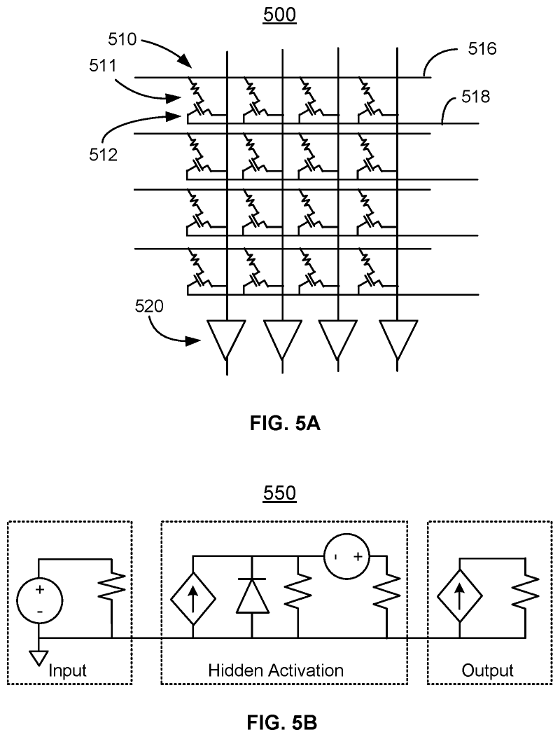

FIG. 4 depicts an embodiment of a learning network trainable using fast target propagation with negative feedback.

FIGS. 5A and 5B depict an embodiment of a weight layer and an embodiment of a neuron usable in an activation layer in a learning network trainable using fast target propagation with negative feedback.

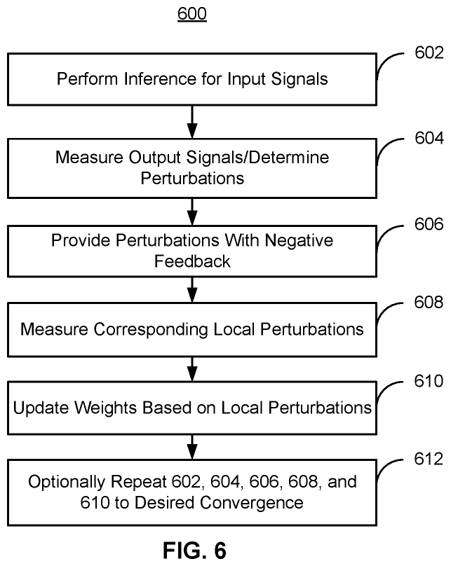

FIG. 6 is a flow chart depicting an embodiment of a method for training a network using negative feedback.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

While backpropagation, particularly in conjunction with stochastic gradient descent, can be used to converge on an assignment of weights for learning networks, it may converge slowly and is not a plausible mechanism for how biological systems function. Other techniques are available that may address some of these drawbacks. For example, difference target propagation is an approximation technique that can be used in connection with training learning networks. In difference target propagation, the local targets for the hidden layers are determined using inverses of the Jacobian matrices describing the weight and activation layers of the learning network. The Jacobian matrix is the first derivative of the output of a particular layer (e.g. a weight layer, an activation layer, or a combination of a weight layer and an activation layer) with respect to the output of the previous layer. These local targets can be used in training the learning network (i.e. in determining how to update the weights for each layer). However, calculating the inverse of each of the Jacobian matrices can be extremely computationally intensive. Consequently, this may dramatically slow the training of the learning network. A technique for addressing this is to provide autoencoders for each layer of weights. The autoencoders are separate learning networks that learn the inverse of the corresponding Jacobian matrix. Each autoencoder thus has its own weight layers and activation layers. However, the autoencoders can greatly increase the number of parameters corresponding to the learning network. For example, these parameters include not only the weights for the learning network, but also the weights for each autoencoder. The autoencoders also require a separate training phase, which slows training of the underlying learning network. Further, as the weights of the learning network are updated during training, the Jacobian matrices change. This means that the targets for the autoencoders change. As a result, the autoencoders may provide a poor approximation of the inverse of the corresponding Jacobian matrices. Even if the autoencoders can provide an approximation of the corresponding Jacobian matrix, storing the weights for the autoencoders can drastically increase the memory footprint for the learning network. This may also be undesirable. Therefore, an improved technique for training learning networks is still desired.

A system including inputs, outputs, and a learning network is described. The learning network is between the inputs and the outputs. The learning network includes layers, each of which includes a weight layer coupled with an activation layer. Connections are between the layers. The weight layer includes multiple weights. The activation layer includes neurons configured to apply at least one activation function. The activation function(s) may include invertible activation function(s). The system also includes a negative feedback network selectively couplable between the outputs and the inputs of the system. The weights are configured to be trained by providing to the inputs input signals corresponding to a target output, measuring output signals at the outputs with the negative feedback network decoupled, perturbing the output signals by perturbations with the negative feedback network coupled between the inputs and the outputs, measuring corresponding perturbations for the connections, and updating the weights based on the corresponding perturbations. The perturbations used with the output signals are based on a difference between the output signals and the target output. In some embodiments, the negative feedback network is an electrical negative feedback network, the input signals are electrical input signals, the output signals are electrical output signals, the perturbations are electrical perturbations, and the corresponding perturbations are corresponding electrical perturbations.

The electrical input signals and the electrical output signals may have a dual relationship. In such embodiments, the negative feedback network is configured such that when connected with the inputs and outputs, the negative feedback network provides, to the inputs, input electrical perturbations that have the dual relationship with the electrical output signals. The negative feedback network is also configured such that when connected with the inputs and outputs, the negative feedback network provides zero output signals for the outputs for duals of the electrical output signals. In some embodiments, the electrical input signals are selected from voltage input signals and current input signals. In such embodiments, the electrical output signals are current output signals where voltage input signals are used. Similarly, the electrical output signals are voltage output signals where current input signals are used. For example, for voltage input signals, the learning network develops current output signals on the outputs. In this example, when the negative feedback network is connected, the negative feedback network provides zero voltage output signals and a current perturbation to the output as well as a voltage perturbation to the inputs. In some embodiments, the negative feedback network includes operational amplifiers having op-amp inputs configured to be selectively connected with the outputs and op-amp outputs configured to be selectively coupled with the inputs of the learning network.

In some embodiments, each of the layers has a first width, where the width is the number of connections to or from the layer. The system may include at least one additional layer having a second width different from the first width. The additional layer(s) include an additional weight layer and/or an additional activation layer.

A learning network including inputs, outputs, weight layers, and activation layers interspersed with the weight layers is described. The weight layers and the activation layers are between the inputs and outputs. Each of the weight layers includes weights. Each of the activation layers includes neurons configured to apply activation function(s). The activation function(s) may be invertible activation function(s). A negative electrical feedback network is selectively couplable between the outputs and the inputs. The weights are configured to be trained by providing electrical input signals corresponding to a target output to the inputs, measuring electrical output signals at the outputs with the negative electrical feedback network electrically decoupled, perturbing the electrical output signals by electrical perturbations with the negative electrical feedback network electrically coupled, measuring corresponding electrical perturbations between the weight layers and the activation layers, and updating the weights based on the corresponding electrical perturbations. The electrical perturbations are based on a difference between the electrical output signals and the target output.

In some embodiments, the electrical input signals and the electrical output signals have a dual relationship. Further, the negative electrical feedback network is configured to provide, when coupled, zero output signals for the outputs for duals of the electrical output signals and input electrical perturbations having the dual relationship with the electrical output signals. The electrical input signals are selected from voltage input signals and current input signals. Thus, the electrical output signals are current output signals and voltage output signals. In some embodiments, the negative electrical feedback network includes operational amplifiers having op-amp inputs configured to be selectively connected with the outputs and op-amp outputs configured to be selectively coupled with the inputs. In some embodiments, the weight and activation layers each have the same width. In some such embodiments, the learning network includes an additional layer having different width from the width of the weight and activation layers. For example, the first, input layer may be a different width than subsequent, hidden layers. Thus, the input layer corresponds to the additional layer. In such embodiments, the negative feedback network is coupled between the output layer and the inputs to the first hidden layer (in other words, the outputs of the input layer). Thus, the source and destination of the negative feedback network have the same dimension (which corresponds to the Jacobian being an invertible/square matrix). Further, the targets are not used at the input layer. Thus, propagating the targets all the way to the input layer via the negative feedback network is unnecessary.

A method that may be used to train a learning network or, in some embodiments, optimize another network, is described. The method includes providing, to the inputs of a network, input signals corresponding to a target output. The network also includes outputs and layers between the inputs and outputs. Each of the layers has a weight layer including weights coupled with an activation layer including neurons configured to apply activation function(s). There are also connections between the layers. The activation function(s) applied may be invertible. The network settles at an operating point based on the input signals. The method also includes measuring output signals at the outputs after the network has settled at the operating point. The operating point is perturbed at the outputs. Negative feedback is provided from the outputs to the inputs during the perturbation. In some embodiments, this is accomplished using negative feedback network. The negative feedback is based on the perturbations at the outputs. The perturbations are based on a difference between the output signals and the target output. The method also includes measuring corresponding perturbations for the connections, and updating the weights based on the corresponding perturbations. In some embodiments, the negative feedback network is provided via an electrical negative feedback network, the input signals are electrical input signals, the output signals are electrical output signals, the perturbations are electrical perturbations, and the corresponding perturbations are corresponding electrical perturbations. The electrical input signals and the electrical output signals have a dual relationship. In some embodiments, perturbing further includes providing zero output signals for the outputs for duals of the electrical output signals. This may be done using the negative feedback network. Further, input electrical perturbations from the negative feedback have the dual relationship with the electrical output signals. In some embodiments, the negative feedback network includes operational amplifiers having op-amp inputs configured to be selectively connected with the outputs and op-amp outputs configured to be selectively coupled with the inputs. This process may be iteratively repeated to provide optimized weights in the weight layers.

FIG. 1 depicts an embodiment of network 100 optimizable using fast target propagation with negative feedback. In some embodiments, network 100 is a learning network. The technique used in conjunction with network 100 is termed fast target propagation because approximations of the desired target output signals for each layer of network 100 may be rapidly determined from the final output signals of network 100 using negative feedback. These local target outputs are also termed corresponding perturbations. Network 100 is described in the context of a learning network. However, in some embodiments, network 100 may be another type of network.

Learning network 100 may be an analog or partially analog system for performing machine learning. Learning network includes inputs 104, outputs 106, and multiple layers 101-1, 101-2, through 101-L (collectively or generically layer(s) 101). Although shown as single lines in FIG. 1, inputs 104, outputs 106, and connections between layers 101 include multiple lines. For example, each layer 101 of learning network may include j inputs and j outputs (i.e. connections), where j is a whole number. The inputs of a particular layer 101 are coupled to the outputs of previous layer. Also shown are input signals 102 provided to inputs 104. Input signals 102 may also be considered the sources of electrical signals provided to inputs 104 (i.e. input signal sources). Output signals are developed on outputs 106 in response to input signals 102. Negative feedback network 130 is selectively coupled between inputs 104 and outputs 106. In some embodiments, this is accomplished via switch 136. Also shown is source 140 that may be used to perturb outputs 106 of learning network 100.

In some embodiments, each layer 101 includes one or more weight layers and one or more activation layers. The weights in the weight layers may take the form of an impedance or other analogous electrical property. For example, a weight layer may be implemented as a crossbar having programmable impedances at the crossings. As such, the weights (e.g. impedances at the crossings of the crossbar) in a weight layer can multiply the signal through the weight layer by a factor (i.e. weight the signal). In some embodiments, a weight may take the form of a programmable resistance, a programmable capacitance, or data stored in a memory cell that is converted into an impedance or admittance and applied to an input signal. Activation layers apply a function to the input signals. Thus, the activation layers may be viewed as including neurons that receive an electrical signal and apply a particular function (the activation function) based on the status of the neuron. For example, the neurons may be hardware neurons formed from a collection of electrical components that provide particular electrical signal(s) out based on the electrical signal(s) received. Alternatively, the neurons may be configured in another manner. For example, the function may be provided digitally using a processor or other technique. In some embodiments, all of the neurons in a layer 101 apply the same activation function. In other embodiments, different neurons in a particular layer 101 apply different activation functions. Activation functions in different layers 101 may differ or be the same. The activation functions may also be invertible. Thus, a particular output is associated with a given input and vice versa. Stated differently, there is a one-to-one correspondence between a given input and a given output. For example, one such invertible activation function is leaky ReLU. Other invertible activation functions exist and may be used.

Layers 101 and learning network 100 may be described by chain matrix parameters, or ABCD parameters. These parameters are also known as transmission parameters. Essentially, the chain matrix parameterization allows the determination of currents at inputs 104 and outputs 106 if the voltages sourced at the inputs 104 and outputs 106 are known. Thus, as used herein, matrices and vectors describe electrical signals (e.g. voltage and/or current) within learning network. Chain matrix parameterization may be used for electrical circuit dual relationships, such as voltage and current, or admittance and impedance. Suppose X represents the input electrical signals from input signals 102 to inputs 104. X may take the form X=[V₀ I₀], where V₀ is the voltage input signal and I₀ is the current input signal. These may be time varying signals. The output of a particular hidden layer 101 (e.g. 101-1, 101-2, . . . 101-(L−1)) is given by Hₗ=[Vₗ Iₗ], where 1 is the index of the hidden layer. The output of a particular hidden layer 101 is also given by Hₗ=fₗ(fₗ₋₁( . . . (f₁ (X))), where fₗ is the function applied by the electrical components of layer l. The outputs of each layer are invertible (e.g. the application of the weights/impedances and invertible activation functions are invertible). Thus, if Y represents the output electrical signals from outputs 106, Y may take the form Y=[V_{L.}−I_{L}], where V_{L} is the voltage output signal and I_{L} is the current output signal. These may be time varying signals. Further, the output of a particular hidden layer 101 is also given by Hₗ=fₗ₊₁⁻¹(fₗ₊₂⁻¹ ( . . . (f_{L}⁻¹ (Y))), where fₗ⁻¹ is the inverse function applied by the electrical components of layer l. The perturbations around the operating point of each layer 101 may be linearly approximated (via the Jacobian matrix of each layer 101) using the chain matrix (transmission) parameterization. It can be determined that the way pairs of small signal voltage and current perturbations propagate in the forward direction is the inverse of the way they propagate in the backward direction. Based on this understanding of learning network 100, the learning network can be trained.

In order to train learning network 100, the loss function is determined based on the target output. As used herein, the term “target output” includes multiple target output signals developed on one or more outputs of a network. The loss function is a difference between the output signals on outputs 106 and the target output. Based on the difference between the output signals and the target output, an electrical signal may be provided to perturb the state of learning network 100. The resulting perturbations between layers 101 may be used to train learning network 100. Source 140 provides a perturbation to the output signals on outputs that is based on the output signals and the target output. However, using independent current and/or voltage sources at a particular set of ports (inputs 104 and outputs 106), it is not possible to simultaneously control both voltage and current at the ports. Because of their dual nature and the nature of the chain matrix parameterization, a current at a particular port (e.g. an output 106) can induce a voltage at another port (e.g. an input 104). However, the use of negative feedback network 130 addresses this issue. In some embodiments, therefore, source 140 may be considered part of negative feedback network 130.

Negative feedback network 130 may be used to ensure that the perturbation applied by source 140 does not induce an undesired perturbation in the dual quantity. For example, a perturbation in current applied by source 140 does not induce a perturbation in voltage at outputs 106. Similarly, if a perturbation in voltage is applied by source 140, it does not induce a perturbation in current at outputs 106. Thus, negative feedback network 130 may be viewed as passing the desired perturbation in an electrical signal from outputs 106 to inputs 104 while providing no induced perturbation in the dual electrical signal. For example, negative feedback network 130 may be viewed as passing toward inputs 104 a perturbation in current from outputs 106, while providing no induced perturbation in voltage at outputs 106. Negative feedback network 130 also ensures that the desired form of the perturbation is passed from outputs 106 to input 104. For example, if a voltage signal is the input signal to inputs 104, then the perturbation applied at inputs 104 is a voltage (though based on current perturbations). Further, negative feedback network 130 applies feedback that is negative in nature to allow the perturbations to linear network 100 to be stable.

In order to train learning network 100, input signals 102 are provided to inputs 104. These input signals are electrical input signals. Learning network 100 is described in the context of voltage input signals, but current input signals may be understood in an analogous manner. The voltage input signals 102 are propagated through learning network 100 and output signals (e.g. current output signals) are developed at outputs 106. Thus, learning network 100 settles at its operating point. This occurs with negative feedback network 130 disconnected (e.g. switch 136 is open). In some embodiments, outputs 106 may be shorted to provide only current output signals. Source 140 provides a perturbation in current based on the loss function (i.e. the difference between the current output signals and the target current output signals). Thus, source 140 may be viewed as determining the loss function in addition to applying the perturbation in current. The perturbation in current is used to drive the current output signals at outputs 106 closer to the target current output. While source 140 applies this perturbation, negative feedback network 130 is connected by closing switch 136. Thus, the perturbation from source 140 is propagated through negative feedback network 130 to inputs 104. In some embodiments, negative feedback network 130 converts this perturbation in current to a voltage perturbation appropriate for inputs 104. The resulting, corresponding perturbations between layers 101 can be measured. These corresponding perturbations indicate how weights (i.e. impedances or other programmable/changeable features of layers 101) should be adjusted to bring output signals closer to the target. The corresponding perturbations to the operating point of network 100 can also be viewed as the local targets layers 101 are desired to output. The weights may then be adjusted. This process may be iteratively performed to optimize the weights (or other programmable/changeable features) of layers 101. Learning network 100 may then be used for the desired application. In so doing, negative feedback network 130 and source 140 may be removed if in-situ training is not desired.

Thus, through the use of negative feedback network 130, source 140 and the configuration of layers 101, learning network 100 may be more rapidly trained. The corresponding perturbations, or local targets, are rapidly developed because of the electrical properties of negative feedback network 130 and layers 101. In some embodiments, the use of negative feedback network 130 may be viewed as computing, via hardware, the inverses of the Jacobian matrices describing the electrical properties of layers 101. Thus, computational expense (e.g. time to train) may be greatly reduced. Further, the additional hardware used for negative feedback network 130 may be relatively small, particularly as compared to autoencoders. Further, the storage of additional parameters may be avoided. Thus, the memory footprint of learning network 100 may be reduced. As such, efficiency of training and performance of learning network 100 may be improved.

FIG. 2 depicts an embodiment of learning network 200 trainable using fast target propagation with negative feedback. Learning network 200 is analogous to learning network 100. Thus, learning network 200 may be analog or partially analog/partially digital and may be used in machine learning. Learning network 200 includes inputs 204, outputs 206, and multiple layers 201-1, 201-2, through 201-L (collectively or generically layer(s) 201) that are analogous to inputs 104, outputs 106, and layers 101. Although shown as single lines in FIG. 2, inputs 204, outputs 206 and connections between layers 201 include multiple lines. For example, each layer 201 of learning network may include j inputs and j outputs (i.e. connections), where j is a whole number. The inputs of a particular layer 201 are coupled to the outputs of previous layer. Also shown are input signals 202 provided to inputs 204. Output signals are developed on outputs 206 in response to input signals 202. Negative feedback network 230 is selectively coupled between inputs 204 and outputs 206, for example via switch 236. Also shown is source 240 that may be used to perturb outputs 206.

Learning network 200 explicitly depicts weight layers 210-1, 210-2 through 210-L (collectively or generically weight layer(s) 210) and activation layers 220-1, 220-2 through 220-L (collectively or generically activation layer(s) 220). Thus, learning network 200 is explicitly a network including weights for weighting signals and a mechanism corresponding to neurons for applying an activation function. As indicated with respect to learning network 100, weights may be programmable impedances or other electrical properties (e.g. data stored in memory that may be converted to impedances) that may be changed and used to weight signals. Additional components and/or layers might be included in layers 201.

Learning network 200 is trained and operates in an analogous manner to learning network 100. In order to train learning network 200, electrical input signals 202 are provided to inputs 204. Learning network 200 is described in the context of voltage input signals, but current input signals may be understood in an analogous manner. The voltage input signals 202 are propagated through learning network 200 and electrical (e.g. current) output signals are developed at outputs 206. This occurs with negative feedback network 230 disconnected. In some embodiments, outputs 206 may be shorted to provide only current output signals. Source 240 provides a perturbation in current based on the loss function. The perturbation in current is used to drive the current output signals at outputs 206 closer to the target current output signals. While source 240 applies this perturbation, negative feedback network 230 is connected. Thus, the perturbation from source 240 is propagated through negative feedback network 230 to inputs 204. In some embodiments, negative feedback network 230 converts this perturbation in current to a voltage perturbation appropriate for inputs 204. The resulting, corresponding perturbations between layers 201 can be measured. Although indicated as being between the activation layer 220 of one layer 201 and the weight layer 210 of the next layer 201, the corresponding perturbations might be determined after weight layers 210 (i.e. between the weight layer 210 and the activation layer 220 of a particular layer 201). These corresponding perturbations indicate how weights (i.e. impedances or other programmable/changeable features of layers 201) should be adjusted to bring output signals closer to the target. The corresponding perturbations can also be viewed as the local targets layers 201 are desired to output. The weights may then be adjusted. This process may be iteratively performed to optimize the weights (or other programmable/changeable features) of layers 201. Learning network 200 may then be used for the desired application. Negative feedback network 230 and source 240 may be removed if in-situ training is not desired.

Learning network 200 shares the benefits of learning network 100. Thus, through the use of negative feedback network 230, source 240 and the configuration of layers 201, learning network 200 may be more rapidly trained. Computational expense (e.g. time to train), additional hardware used, and memory footprint may be reduced. Consequently, efficiency of training and performance of learning network 200 may be improved.

FIG. 3 depicts an embodiment of learning network 300 trainable using fast target propagation with negative feedback. Learning network 300 is analogous to learning network(s) 100 and/or 200. Learning network 300 may be analog or partially analog/partially digital and may be used in machine learning. Learning network 300 includes inputs 304-1 through 304-n (collectively or generically input(s) 304) analogous to inputs 104/204 and outputs 306-1 through 306-n (collectively or generically 306) analogous to outputs 106/206. Also shown are input signal sources 302-1 through 302-n (collectively or generically input signal source(s) or input signal(s) 302) analogous to input signals 102/202. Although including layers that are analogous to layers 101/201, learning network is simply indicated as including weight layers 310-1 through 310-L (collectively or generically weight layer(s) 310) and activation layers 320-1 through 320-L (collectively or generically activation layer(s) 320) that are analogous to weight layers 210 and activation layers 220. In the embodiment shown, weight layers 310 and activation layers 320 are interleaved. Thus, the inputs of a particular activation layer 320 are coupled to the outputs of previous weight layer 310, and vice versa. Output signals are developed on outputs 306 in response to input signals 302. Negative feedback network 330 is selectively coupled between inputs 304 and outputs 306. In the embodiment shown, voltage is input to network 300 and current output. Other configurations of networks, including but not limited to current input and voltage output, are possible.

A particular embodiment of negative feedback network 330 is shown. Negative feedback network 330 includes individual feedback networks 330-1 through 330-n (collectively or generically negative feedback network(s) 330). Negative feedback networks 330-1 through 330-n include operational amplifiers (op-amps) 332-1 through 332-n (collectively or generically op-amps 332), switches 334-1 through 334-n (collectively or generically switch(es) 334), switches 336-1 through 336-n (collectively or generically switch(es) 336), and resistors 338-1 through 338-n (collectively or generically resistor(s) 338). Although a particular configuration is shown, different configurations may be used. For example, in order to ensure negative feedback, the input terminals of each op-amp 332 are desired to be appropriately corrected. This may be accomplished by testing learning network 300 with perturbations from source(s) 340 (or other sources) and connecting op-amps 332 appropriately. Although resistors 338 are shown as the same, the value and/or type of resistors 338 may differ. Further, another component capable of developing a voltage to provide to inputs 304 may be used.

Learning network 300 is trained and operates in an analogous manner to learning network(s) 100 and/or 200. In order to train learning network 300, electrical input signals 302 are provided to inputs 304. Learning network 300 is described in the context of voltage input signals, but current input signals may be understood in an analogous manner. The voltage input signals 302 are propagated through learning network 300 and electrical (e.g. current) output signals are developed at outputs 306. This occurs with negative feedback network 330 disconnected. Thus switches 336 are open. In some embodiments, outputs 306 may be shorted to provide only current output signals. This can be accomplished by closing switches 334 and reading the current developed on outputs 306/through switches 334. Thus, the current output signals (i.e. output signals that have a dual relationship with the voltage input signals) are thus measured. Consequently, the loss function for learning network (i.e. the difference between the current output signal and the target output for each output 306) can be determined.

Each of sources 340 provides a perturbation in current based on the loss function for the corresponding ports 304 and 306. The perturbation is such that the sum of the perturbation and the current output signal from each output 306 is closer to the target output for each output 306 than the current output signal alone. The perturbation in current is, therefore, used to drive the current output signals at outputs 306 closer to the target outputs. While sources 340 apply this perturbation, negative feedback networks 330 are connected by closing switches 338. In addition, switches 334 opened. Thus, the total current to each op-amp 332 includes the desired perturbations based on the loss function provided by sources 340 and the measured current through outputs 306.

Negative feedback networks 330 propagate the perturbations from sources 340 to inputs 304. Op-amps are known to have two properties: (1) current does not pass through the input terminals of an op-amp and (2) when operating under negative feedback, the voltage drop across the input terminals of the op-amp is zero. Learning network 300 is configured such that op-amps 332 are under negative feedback. Thus, not only does current not pass through the input terminals of op-amps 332, but the voltage difference between their input terminals to zero for each of outputs 306. As a result, currents are sourced to outputs 306 while the voltage drops across output 306 are zero. Thus, the op-amps 332 quickly and automatically provide an input source configuration that nullifies the output voltages (i.e. the duals of the sourced currents). This allows the desired exact gradient vector (e.g. the current perturbations from sources 340) to be passed back through the chain matrices (i.e. through learning network 300). In the embodiment shown, negative feedback networks 330 convert the sourced current to an input voltage via resistors 338. Resistors 338 may have the same or different resistances in different negative feedback networks 330. In some embodiments, other impedances and/or other techniques may be used to convert the perturbations (current from sources 340) to the desired input (voltages).

The input perturbations from negative feedback networks 330 propagate forward through learning network 300. These perturbations can be measured within learning network 300, for example at the connections between layers 310 and 320. This provides a measure of the local target, or how the weights in the nearest weight layer 310 preceding the measurement position should be adjusted. Although the perturbations are indicated in FIG. 3 as being measured between an activation layer 320 and the next weight layer 310, in some embodiments, the perturbations can be measured between a weight layer 310 and the next activation layer 320. The weights in each weight layer 310 may then be adjusted in accordance with the measured perturbation. This process may be iteratively performed to optimize the weights of layers 310. Learning network 300 may then be used for the desired application. Negative feedback networks 330 and sources 340 may be removed if in-situ training is not desired.

Learning network 300 shares the benefits of learning network(s) 100 and/or 200. Thus, through the use of negative feedback networks 330, sources 340 and the configuration of layers 310 and 320 (e.g. same width/number of inputs and outputs, invertible activation functions in some embodiments), learning network 300 may be more rapidly trained. Computational expense (e.g. time to train), additional hardware used, and memory footprint may be reduced. Consequently, efficiency of training and performance of learning network 300 may be improved.

FIG. 4 depicts an embodiment of learning network 400 trainable using fast target propagation with negative feedback. Learning network 400 is analogous to learning network(s) 100, 200, and/or 300. Learning network 400 may be analog or partially analog/partially digital and may be used in machine learning. Learning network 400 includes inputs 404, outputs 406, and layers 401-1 through 401-L (collectively or generically layer(s) 401) that are analogous to inputs 104/204, outputs 106/206, and layers 101/201/310 and 320. Also shown are input signal sources 402 that are analogous to input signals 102/202/302. Negative feedback network 430 is selectively coupled between inputs 404 and outputs 406.

Learning network 400 also includes an additional layer 401-(L+1). In another embodiment, additional layer 401-(L+1) might be located elsewhere. Layer 401-(L+1) has a different number of inputs 404A and/or outputs 406A than remaining layers 401. Consequently, layer 401-(L+1) is desired to be treated separately from remaining layers 401. Layer 401-(L+1) is treated as a single layer network. In contrast, negative feedback network 430 and source 440 are used with remaining layers 401. The loss function for the single layer 401-(L+1), the corresponding inputs (and thus the outputs from layer 401-L), and the weights within layer 401 can be determined. This information can be used in training remaining layers 401 as described herein. As a result, a network in which not all of the layers have the same width may be decomposed into one or more single layer networks (where the width changes) and one or more networks analogous to learning networks 100, 200, and 300, and layers 401 that can be trained using negative feedback as described herein.

Learning network 400 shares the benefits of learning network(s) 100, 300, and/or 300. Thus, through the use of negative feedback network 430, source 440 and the configuration of layers 410, learning network 400 may be more rapidly trained. Computational expense (e.g. time to train), additional hardware used, and memory footprint may be reduced. Consequently, efficiency of training and performance of learning network 400 may be improved. Moreover, learning network 400 may be trained despite including one or more layers that have a different width than other layers.

FIGS. 5A and 5B depict embodiments of weight layer 500 and neuron 550 that may be used in an activation layer. Neuron 550 of FIG. 5B provides an invertible activation function (leaky ReLU). FIG. 5A depicts an embodiment of a weight layer 500 in a learning network trainable using fast target propagation with negative feedback. Weight layer 500 may thus be analogous to weight layers 210 and 310 and portion(s) of layers 101, 201, and/or 401. Weight layer 500 is provided as an example and is not intended to limit the techniques described herein to the architecture shown.

Weight layer 500 includes resistive cells 510. For clarity, only one resistive cell 510 is labeled. However, multiple cells 510 are present and arranged in a rectangular array (i.e. a crossbar array in the embodiment shown). Also labeled are corresponding lines 516 and 518 and current-to-voltage sensing circuit 520. Each resistive cell 510 includes a programmable impedance 511 and a selection transistor 512 coupled with line 518. Bit slicing may be used to realize high weight precision with multi-level cell devices.

In operation, an input signal is provided to a particular line (e.g. line 516). In some embodiments, a DAC converts digital input data to an analog voltage that is applied to the appropriate row in the crossbar array 500. The row for resistive cell 510 is selected by an address decoder (not shown in FIG. 5) by enabling line 518 and, therefore, transistor 512. A current corresponding to the impedance of programmable impedance 511 is provided to current-to-voltage sensing circuit 520. Each row in the column of resistive cell 511 provides a corresponding current. Current-to-voltage sensing circuit 520 senses the partial sum current and converts this to a voltage. In some embodiments, this voltage is provided to the next layer. This layer may be an activation layer (not shown). Thus, using the configuration depicted in FIG. 5, a weight layer may perform a vector-matrix multiplication using data stored in resistive cells 510. In other embodiments, other techniques for weighting signals input to the weight layer and other architectures of the weight layer may be used. While still utilizing electric signals, such as voltage and/or current, such embodiments may not use resistance or impedance to represent weights. For example, a weight may be stored in SRAM cells of a vector-matrix multiplication unit. Such a vector-matrix multiplication unit uses the data (weight) from the SRAM cells to provide weighted capacitance voltages and perform a vector matrix multiplication.

In a learning network using weight layer 500, the corresponding perturbations provided by a negative feedback network (not shown in FIG. 5A) analogous to negative feedback networks 130, 230, 330, and/or 430 may be read from the inputs to or the outputs from weight layer 500. Thus, voltages from lines 516 or the outputs of sensing circuits 520 may be read. Consequently, a variety of hardware may be used in conjunction with learning networks 100, 200, 300, and/or 400 and the techniques described herein.

FIG. 6 is a flow chart depicting an embodiment of method 600 for training a network using negative feedback. Although particular processes are shown in an order, the processes may be performed in another order, including in parallel. Further, processes may have substeps. Method 600 may be used for networks in which the layers have the same width. For learning networks having different widths, method 600 may be used on a subset of the layers having the same width (i.e. the same number of inputs and outputs). Method 600 is described in the context of learning network 300. However, method 600 may be used with other networks including but not limited to networks 100, 200, and/or 400.

An inference is performed, at 602. Thus, input signals are provided to the inputs of a learning network and the network allowed to reach an operating point (e.g. a steady state). 602 is performed with no negative feedback being connected between the inputs and outputs. At 604, the output signals are measured while the system is at its operating point and the loss function determined. In addition, 604 may include ensuring that only current or only voltage signals are developed as the output signals. In some embodiments, 604 includes determining the difference between the output signals at the operating point and the target output. The corresponding perturbations to the outputs that would bring the output signals closer to the target output are also determined at 604. The operating point is perturbed at the outputs, at 606. While the outputs are perturbed, negative feedback is provided from the outputs to the inputs, at 606. In some embodiments, this is accomplished using a negative feedback network. The negative feedback provided to the inputs is based on the perturbations at the outputs. The corresponding perturbations that are local to the layers are measured, at 608. Thus, the local targets for the hidden layers within the network are determined at 608. The weights may then be updated based on the corresponding perturbations/local targets within the learning network, at 610. This process may be iteratively repeated until a desired state is reached, at 610. Thus, an optimized solution to the problem of setting the weights (e.g. programming the impedances or other hardware) may be determined.

For example, voltage input signals 302 are provided to inputs 304, at 600. The voltage input signals 302 are propagated through learning network 300 and current output signals are developed at outputs 306. Thus, an inference is performed. 602 is performed with switches 336 are open. In some embodiments, switches 334 are closed such that outputs 306 are shorted and current through the shorts read at 604. Thus, current output signals are read while no voltage is developed at outputs 306. The difference between these measured currents at outputs 306 and the target output is also determined at 604.

Each of sources 340 provides a perturbation in current based on the difference between the current output signals and the target outputs for the corresponding outputs 306, at 606. Feedback is also provided at 606. Thus, for learning network 300, switches 336 are closed and switches 334 opened. The perturbation in current drives the current output signals at outputs 306 closer to the target outputs.

Negative feedback networks 330 automatically propagate the perturbations from sources 340 to inputs 304. Thus, current does not pass through the input terminals of op-amps 332 and the voltage difference between op-amp 332 input terminals is driven to zero. As a result, currents are sourced to outputs 306 while the voltage drops across the output ports are zero. This allows the desired exact gradient vector (e.g. the current perturbations from sources 340) to be passed back through the chain matrices (i.e. through learning network 300). The input perturbations from negative feedback networks 330 may also automatically propagate forward through learning network 300. These perturbations are measured within learning network 300, at 608. The weights in each weight layer 310 may then be adjusted in accordance with the measured perturbation, at 610. This process may be iteratively performed to optimize the weights of layers 310, via 612.

Method 600 thus allows a learning network to be trained more rapidly, with reduced computational expense, reduced additional hardware, and reduced memory footprint. Further, a biologically plausible technique may be used. Consequently, efficiency of training and performance of a learning network may be improved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a plurality of inputs;
a plurality of outputs;
a learning network between the plurality of inputs and the plurality of outputs, the learning network including a plurality of layers, each of the plurality of layers including a weight layer including a plurality of weights coupled with an activation layer including a plurality of neurons configured to apply at least one activation function, a plurality of connections coupling the plurality of layers; and
a negative feedback network selectively couplable between the plurality of outputs and the plurality of inputs;
wherein the plurality of weights are configured to be trained by providing input signals corresponding to a target output to the plurality of inputs, measuring output signals at the plurality of outputs with the negative feedback network decoupled between the plurality of outputs and the plurality of inputs, perturbing the output signals by a plurality of perturbations with the negative feedback network coupled between the plurality of inputs and the plurality of outputs, measuring corresponding perturbations for the plurality of connections, and updating the weights based on the corresponding perturbations, the plurality of perturbations being based on a difference between the plurality of output signals and the target output.

2. The system of claim 1, wherein the negative feedback network is an electrical negative feedback network, the input signals are electrical input signals, the output signals are electrical output signals, the plurality of perturbations is a plurality of electrical perturbations, the corresponding perturbations are corresponding electrical perturbations.

3. The system of claim 2, wherein the electrical input signals and the electrical output signals have a dual relationship; and
wherein, for being connected with the plurality of inputs and the plurality of outputs, the negative feedback network is configured to provide zero output signals for the outputs for duals of the electrical output signals and input electrical perturbations having the dual relationship with the electrical output signals.

4. The system of claim 3, wherein the electrical input signals are selected from voltage input signals and current input signals and wherein the electrical output signals are current output signals for the voltage input signals and voltage output signals for the current input signals.

5. The system of claim 2, wherein the negative feedback network includes a plurality of operational amplifiers having op-amp inputs configured to be selectively connected with the plurality of outputs and op-amp outputs configured to be selectively coupled with the plurality of inputs.

6. The system of claim 2, wherein each of the plurality of layers has a first width.

7. The system of claim 6, wherein the system includes:
at least one additional layer having a second width different from the first width, the at least one additional layer including at least one of an additional weight layer or an additional activation layer.

8. The system of claim 1, wherein the at least one activation function is at least one invertible activation function.

9. A learning network, comprising:
a plurality of inputs;
a plurality of outputs;
a plurality of weight layers;
a plurality of activation layers interleaved with the plurality of weight layers, the plurality of weight layers and the plurality of activation layers being between the plurality of inputs and the plurality of outputs, each of the plurality of weights layer including a plurality of weights, each of the plurality of activation layers an activation layer including a plurality of neurons configured to apply at least one activation function; and
a negative electrical feedback network selectively couplable between the plurality of outputs and the plurality of inputs;
wherein the plurality of weights are configured to be trained by providing electrical input signals corresponding to a target output to the plurality of inputs, measuring electrical output signals at the plurality of outputs with the negative electrical feedback network electrically decoupled between the plurality of outputs and the plurality of inputs, perturbing the electrical output signals by a plurality of electrical perturbations with the negative electrical feedback network electrically coupled between the plurality of inputs and the plurality of outputs, measuring corresponding electrical perturbations between the plurality of weight layers and the plurality of activation layers, and updating the weights based on the corresponding electrical perturbations, the plurality of electrical perturbations being based on a difference between the plurality of electrical output signals and the target output.

10. The learning network of claim 9, wherein the electrical input signals and the electrical output signals have a dual relationship; and
wherein, for being connected with the plurality of inputs and the plurality of outputs, the negative electrical feedback network is configured to provide zero output signals for the outputs for duals of the electrical output signals and input electrical perturbations having the dual relationship with the electrical output signals.

11. The learning network of claim 10, wherein the electrical input signals are selected from voltage input signals and current input signals and wherein the electrical output signals are current output signals for the voltage input signals and voltage output signals for the current input signals.

12. The learning network of claim 9, wherein the negative electrical feedback network includes a plurality of operational amplifiers having op-amp inputs configured to be selectively connected with the plurality of outputs and op-amp outputs configured to be selectively coupled with the plurality of inputs.

13. The learning network of claim 9, wherein the plurality of weight layers and the plurality of activation layers have a first width and wherein the learning network includes an additional layer having a second width different from the first width.

14. The learning network of claim 9, wherein each of the plurality of activation layers applies at least one invertible activation function.

15. A method, comprising:
providing, to a plurality of inputs of a network, input signals corresponding to a target output, the network including the plurality of inputs, a plurality of outputs, and a plurality of layers between the plurality of inputs and the plurality of outputs, each of the plurality of layers including a weight layer including a plurality of weights coupled with an activation layer including a plurality of neurons configured to apply at least one activation function, a plurality of connections between the plurality of layers, the network settling at an operating point based on the input signals;
measuring output signals at the plurality of outputs after the network has settled at the operating point;
perturbing, at the outputs, the operating point with a plurality of perturbations, a negative feedback network providing feedback, from the plurality of outputs to the plurality of inputs, based on the plurality of perturbations, the plurality of perturbations being based on a difference between the output signals and the target output,
measuring corresponding perturbations for the plurality of connections, and
updating the weights based on the corresponding perturbations.

16. The method of claim 15, wherein the negative feedback network is an electrical negative feedback network, the input signals are electrical input signals, the output signals are electrical output signals, the plurality of perturbations is a plurality of electrical perturbations, the corresponding perturbations are corresponding electrical perturbations.

17. The method of claim 16, wherein the electrical input signals and the electrical output signals have a dual relationship; and wherein the perturbing further includes:
the negative feedback network providing zero output signals for the outputs for duals of the electrical output signals and input electrical perturbations having the dual relationship with the electrical output signals.

18. The method of claim 17, wherein the negative feedback network includes a plurality of operational amplifiers having op-amp inputs configured to be selectively connected with the plurality of outputs and op-amp outputs configured to be selectively coupled with the plurality of inputs.

19. The method of claim 16, wherein the at least one activation function is at least one invertible activation function.

20. The method of claim 16, further comprising:
repeating the providing, measuring, perturbing, measuring, and updating.
